(19) United States
(12) Patent Application Publication
(10) Pub. No.: US 2006/0150428 A1
(43) Pub. Date: Jul. 13, 2006

(54) Quick-change tools

(76) Inventor: Eric J. Baculy, Cedar Springs, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/524,575

(22) PCT Filed: Aug. 19, 2003
(86) PCT No.: PCT/US03/25725

§ 371 Date: Aug. 8, 2005

(30) Foreign Application Priority Data
Aug. 19, 2002 (US) 60404368

(51) Int. Cl. B23D 45/16

(52) U.S. Cl. 30/388; 83/666

(57) ABSTRACT

A tool having a quick-change mechanism for replacing tool implements on a shaft, post or handle comprising a shaft, post or handle having a flange and a threaded connector. The tool further includes a tool implement adapted to be received on the shaft, post or handle adjacent thc flange. The tool also includes a stabilizer washer adapted to be received on the shaft, post or handle adjacent the work implement. A threaded fastener is adapted to be threaded onto the threaded connector of the shaft, post or handle whereby the tool implement and the stabilizer washer are retained on the shaft, post or handle by the fastener, and wherein the tool implement and the stabilizing washer are configured to allow removal of the tool implement without removing the fastener from the shaft, post or handle.

### FIELD OF THE INVENTION

This invention relates to mechanisms for attachment and removal of tool implements on power tools or hand tools, and more particularly to mechanisms that facilitate quick changing of tool implements, such as lawn mower blades, saw blades, sander discs, grinder, scraper blades, wheels, and the like.

### BACKGROUND OF THE INVENTION

Changing of rotating implements on power tools, such as circular saws, table saws, etc., generally requires unscrewing a nut or bolt which holds the blade or other tool implement on a rotatable shaft or arbor. The mechanism for attaching the rotatable tool part to the shaft generally comprises a plurality of components such as nuts, bolts, washers, stabilizers and the like. Often, all of these components must be completely removed from the shaft to facilitate removal of a saw blade or other rotatable tool implements from the shaft. As a result, changing of saw blades or other rotatable tool implements can be difficult and require a substantial amount of time. Further, because a nut or bolt, and at least one other element such as a washer or stabilizer must be completely removed from the shaft or arbor in order to allow changing of the saw blade or other rotatable tool implements, there is a substantial chance that parts could become lost (e.g., fall in a pile of sawdust) during the changing of the blade or other rotatable tool implement.

A variety of special purpose saw blades are sold for use in cutting different materials and/or for achieving different cutting results in the same material. Similarly, there are a variety of different grinder wheels, sander discs and other rotatable tool implements designed for a particular application or result. Accordingly, there is often a need for changing a saw blade or other rotatable tool implement to achieve a particular result in a particular application. Therefore, there is a need for a mechanism which allows quick removal of a rotatable tool implement from a shaft and quick replacement with a different rotatable tool implement.

U.S. Pat. No. 4,787,147 discloses a quick-change mechanism to change rotatable work contacting members, such as circular saw blades, which have diamond arbor central holes. The mechanism is a single bolt-on attachment including a disc with a raised protruding center body shaped to fit a standard diamond center blade. The blade is locked in place by expanding opposite undercut sections. The expanding sections have undercut slots just above the upper disc surface and serve to wedge the blade down when moved radially outward. Wedging sliding locks of the undercut sections are integral with radially sliding members, which move in and out in complementary “V” slots cut into the blade holding disc. Coil springs inset in cavities drilled into the inside ends of the wedging and sliding locks exert constant outward pressure on the wedging and sliding locks. When the drive shaft is rotating, the outwardly directed locking pressure of the springs is significantly supplemented by centrifugal force. A spiral lock ring is inset on the outer diameter surface of the blade holder disc to limit outward travel of the wedging and sliding locks and to provide circumferential support of the assembly. The blade is removed by pinching the two slide locks and moving them inwardly.

While this mechanism allows quick removal of a saw blade or other rotatable tool part from a shaft, the mechanism is relatively complex and is believed to be undesirable because it relies on coil springs that can become damaged by repeated use and exposure to high temperatures, such as those to which circular saw blades and other rotatable tool parts are sometimes subjected during periods of extended use. This mechanism is therefore believed to be subject to failure, especially when used repeatedly and/or for extended periods of time.

U.S. Pat. No. 4,730,952 discloses a quick-change mechanism for circular saw blades. The mechanism includes a splined slide lock having lands and grooves, with the lands extending as sliding lock fingers and having foot holder slots, a splined circular saw blade holder, an installation bolt passing through both the splined slide lock and the splined circular saw blade holder, a coil spring for axial placement in a centered cavity on the installation bolt, and a release button having depending spring legs and feet and a centered hole to pass an allen wrench. According to the patent, the user of the power saw rapidly changes circular saw blades by manipulating only the circular saw blade and the release button using one's fingers and hands in a few seconds of time. However, the mechanism is relatively complicated and utilizes a spring, which is believed to result in poor reliability, especially after repeated use and/or extended use.

U.S. Pat. No. 4,657,428 also describes a quick-change mechanism for circular saw blades and other spinning disc devices. The mechanism includes axial splines on a drive shaft having lands and grooves, a radial slot to receive a rotatable work-contacting member in its operational position, complementary axial splines having lands and grooves on the rotatable work contacting member, and a complementary splined locking member. However, this mechanism is also relatively complicated and relies on the use of a compression spring, and is therefore believed to be unreliable, especially after repeated use and/or extended use.

### SUMMARY OF THE INVENTION

The invention provides a simple, safe and reliable mechanism for achieving quick changing of tool implements on a shaft, post or handle. The mechanism is useable with a variety of power tools including hand held circular saws, table saws, sanders and grinders having rotatable discs, etc.

The quick-change mechanism of the invention includes a tool implement (e.g., a circular saw blade) adapted to be received on a shaft, post or handle immediately adjacent a flange, a stabilizing washer adapted to be received on the shaft, post or handle immediately adjacent the tool implement, and a threaded fastener adapted to be threaded onto a threaded connector of the shaft, post or handle immediately adjacent the stabilizing washer, whereby the tool implement and the stabilizing washer are retained against the flange by the threaded fastener. To facilitate quick changing of the tool implement, the tool implement and stabilizing washer are configured to allow removal of the tool implement without removing the fastener from the shaft, post or handle.

In one aspect of the invention, the stabilizing washer has a non-circular profile, and the tool implement includes an aperture configured to allow a rotatable shaft and a stabilizing washer to pass through the aperture when the tool implement and stabilizing washer are arranged in a first conformation, and prevent the stabilizing washer from passing through the aperture when the tool implement and the stabilizing washer are rotated with respect to one anther into another conformation.

These and other features, advantages and objects of the present invention will be further understood and appreciated by those skilled in the art by reference to the following specification, claims and appended drawings.

### BRIEF DESCRIPTION OF THE DRAWINGS

FIG. 1 is a side elevational view of a table saw employing a quick-change circular saw blade in accordance with the invention.

FIG. 2 is a perspective view illustrating a quick circular saw blade and stabilizing washer in accordance with the invention.

FIG. 3 is a perspective view of the quick-change circular saw blade and stabilizing washer, illustrating certain details thereof.

FIG. 4 is a perspective of the quick-change circular saw blade and stabilizing washer arranged in an orientation with respect to each other to permit removal of the blade without removing a nut for holding the blade on a shaft.

FIG. 5 is an elevational view of the stabilizing washer showing the side of the stabilizing washer which abuts the surface of the quick-change blade.

FIGS. 6 and 7 are perspective views illustrating the manner in which the quick-change blade and stabilizing washer are assembled onto a power driven rotatable shaft.

FIG. 8 is a perspective view of the stabilizing washer shown in FIG. 5.

FIG. 9 is a perspective view of a lawnmower utilizing a quick-change lawnmower blade in accordance with the invention.

FIG. 10 is a bottom perspective view of a quick-change blade of this invention.

FIG. 11 is a side elevational view of a quick-change lawnmower blade of the invention.

FIG. 12 is a top view of a stabilizing washer used with the quick-change lawnmower blade of this invention.

FIG. 13 is a top view of an alternative stabilizing washer used with a quick-change lawnmower blade of this invention.

FIGS. 14 and 15 illustrate the manner in which the quick-change lawnmower blade of this invention is installed on a driven rotatable lawnmower shaft.

### DESCRIPTION OF THE PREFERRED EMBODIMENTS

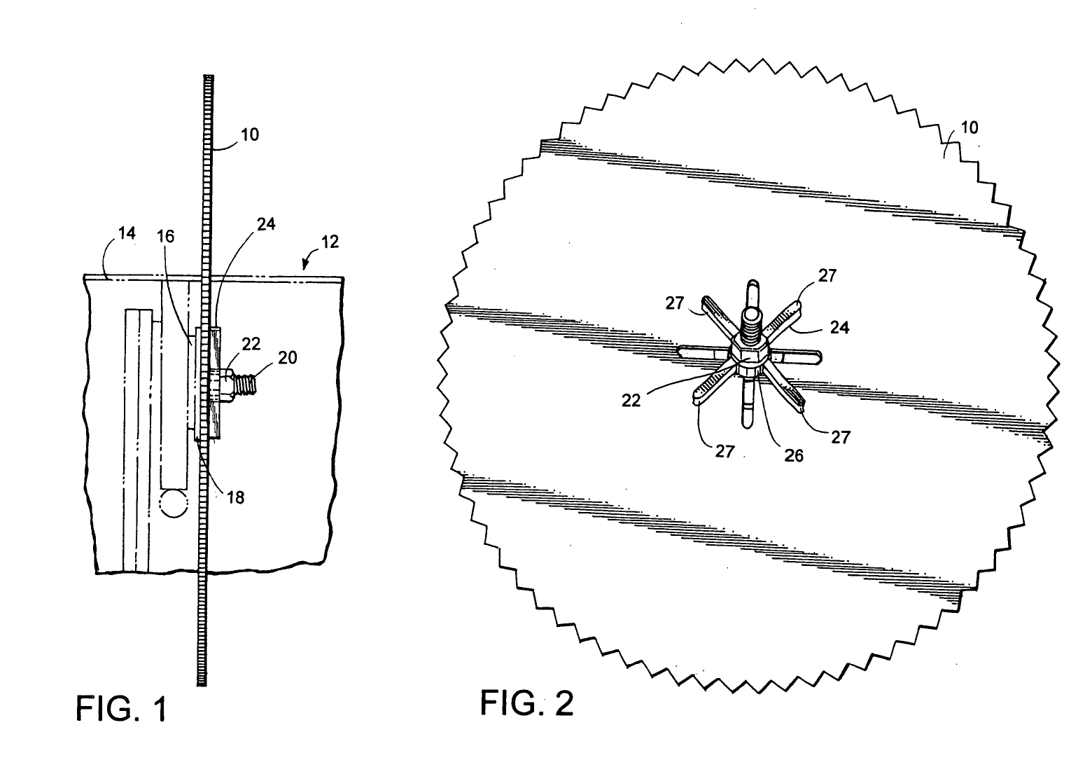

Shown in FIG. 1 is a circular saw blade 10 (work implement) mounted on a table saw 12 having a table top 14 and a power driven rotatable shaft 16. Rotatable shaft 16 includes an annular flange 13 and a threaded connector 20. Blade 10 is located immediately adjacent annular flange 18, and a stabilizing washer adapted to be received on threaded end portion 20 of rotatable shaft 16 is located immediately adjacent blade 10. Fastener nut 22 is tightened onto threaded end portion 20 of shaft 16 to securely retain blade 10 and a one-piece stabilizing washer 24 between annular flange 18 and nut 22.

As shown in FIG. 2, stabilizing washer 24 includes a central hub portion 26 which may be substantially circular in shape, and a plurality of projecting arms 27 which extend radially away from hub portion 26. Arms 27 are integral with and rigidly connected to central hub portion 26, i.e., arms 27 are not movable with respect to hub portion 26.

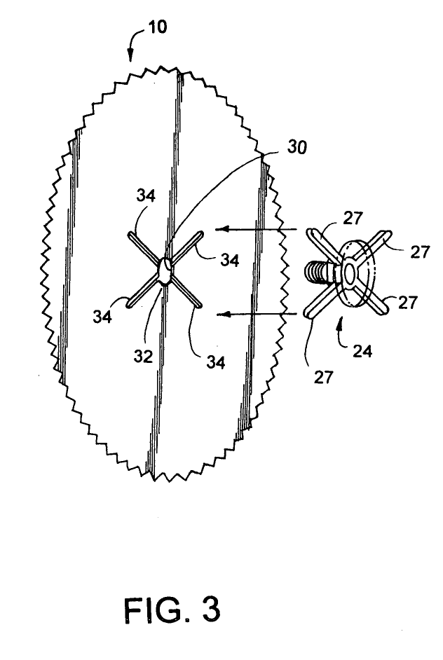

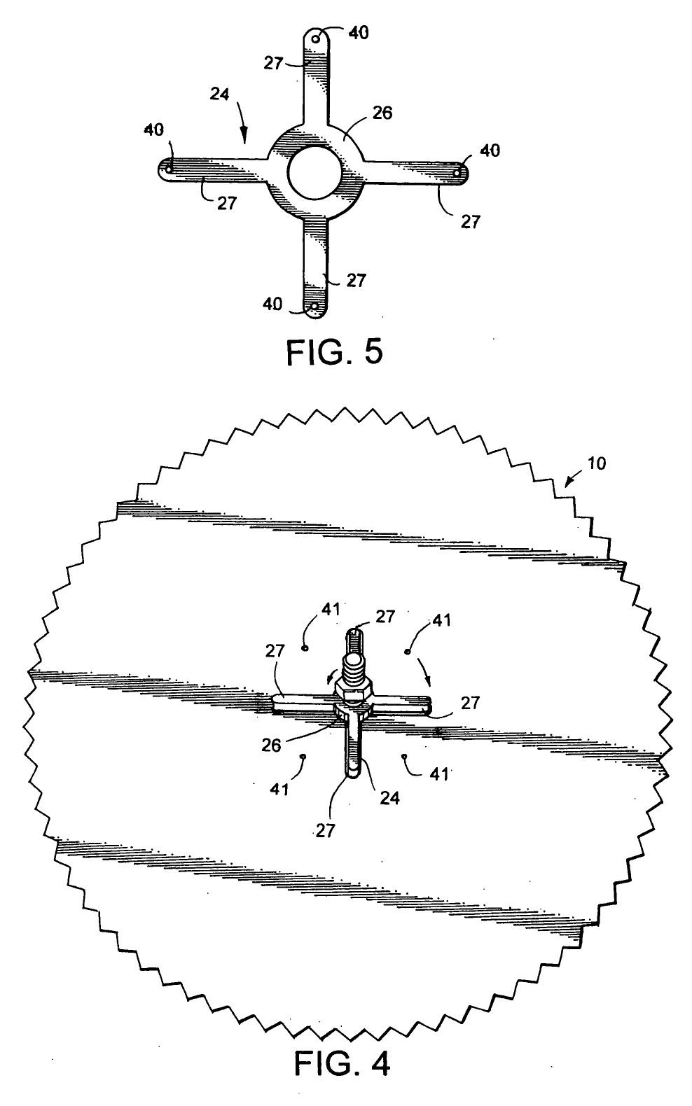

As shown in FIG. 3, blade 10 includes an aperture 30 having a circular portion 32 adapted to allow hub section 26 of stabilizing washer 24, and fastener nut 22 to pass through aperture 30. Aperture 30 also includes a plurality of projecting arms 34 which extend radially away from circular portion 32 of aperture 30. The arms 34 of aperture 30 are adapted to allow arms 27 of stabilizing washer 24 to pass through aperture 30 when blade 10 and stabilizing washer 24 are oriented in the conformation shown in FIG. 4. However, when stabilizing washer 24 is rotated (other than an angle which is a multiple of 90 degrees), arms 27 of stabilizing washer 24 overlap surfaces of blade 10 preventing stabilizing washer 24 from passing through aperture 30 of blade 10.

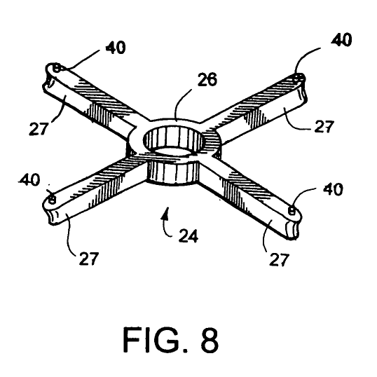

In FIG. 5, there is shown an elevational view of the side of stabilizing washer 24 which abuts the surface of blade 10. The illustrated stabilizing washer 24 includes a pin 40 (FIG. 8) that projects into small circular apertures 41 of blade 10 when stabilizer washer 24 is aligned with blade 10 and abuts blade 10 as shown in FIGS. 1 and 2. Insertion of pins 40 of stabilizing washer 24 into circular apertures 41 of blade 10 and tightening of nut 22 prevents movement of stabilizing washer 24 relative to blade 10.

Shaft 16, blade 10, and nut 22 may be made of generally any material known to be useful for manufacturing conventional power driven rotatable shafts, circular saw blades, and nuts, respectively. In order to prevent shearing of pins 40 from stabilizing washer 24, stabilizing washer 24 is preferably made of a metal, such as a steel, aluminum or stainless steel casting. However, relatively tough plastic materials such as ABS resin may be employed.

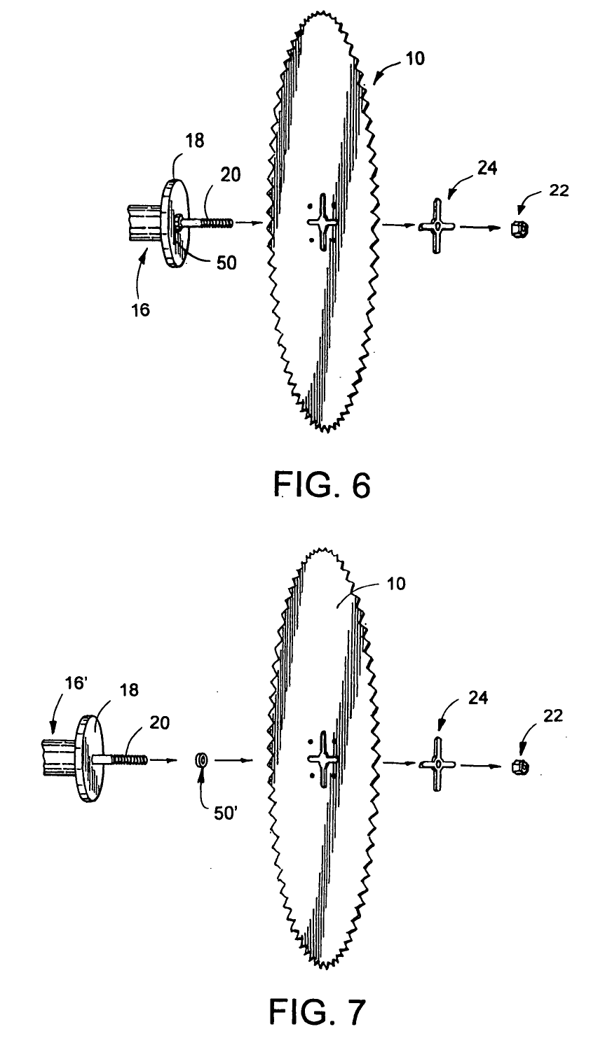

Installation of blade 10 on shaft 16 and removal of blade 10 from shaft 16 are illustrated in FIGS. 6 and 7. In FIG. 6, there is shown a power driven rotatable shaft 16 having an annular flange portion 18 and a reduced diameter threaded portion 20 onto which blade 10 is mounted. FIG. 6 represents an arrangement in which shaft 16 is configured for use with the quick-change system of the invention without any adaptation. In particular, shaft 16 includes an integral circular step portion 50, preferably having a thickness about equal to the thickness of blade 10 and a diameter approximately equal to the diameter of the circular portion 32 of aperture 30. In order to allow blade 10 to be passed over stabilizing washer 24 and nut 22 without removing stabilizer 24 or nut 22, the diameter of integral step portion 50 of shaft 16 is at least equal to the diameter of nut 22. A power tool sold with driven rotatable shaft 16 configured for use with blade 10 and stabilizing washer 24 may have a preinstalled blade 10. In this case, the user may never have to remove nut 22 or stabilizing washer 24 from threaded portion 20 of shaft 16 to replace blade 10 with another blade. However, nut 22 and stabilizing washer 24 may be removed if necessary, to effect maintenance or repair. Once blade 10 has been positioned on shaft 16 with the inner edges of the circular portion 32 of aperture 30 abutting against the outer edge surface of step portion 50, stabilizing washer 24 is slid along threaded shaft 20 into abutment with blade 10, with pins 40 of stabilizing washer 24 passing into apertures 41 of blade 10. Thereafter, nut 22 is threaded onto threaded portion 20 of shaft 16 and tightened to securely hold blade 10 and stabilizing washer 24 between flange 18 and nut 22.

FIG. 7 represents an alternative embodiment, which is substantially the same as the embodiments shown in FIG. 6, except that shaft 16′ does not have a step portion 50 as shown in FIG. 6. Instead, a spacer or washer 50′ is passed over threaded portion 20 of shaft 16′ into abutment with flange 18. Thereafter, blade 10, stabilizing washer 24 and nut 22 are installed as generally described above with respect to FIG. 6. Spacer or washer 50′ may be retained on flange 18 using double sided tape if desired. Alternatively, spacer or washer 50′ may be magnetized to facilitate retention of washer 50′ on a metal flange 18. Finally, if desired, washer 50′ and flange 18 may be configured with interlocking mechanical features (e.g., tabs, grooves, etc) to facilitate retention and removal of washer 50′ from flange 18.

For either of the embodiments shown in FIGS. 6 and 7, blade 10 may be replaced with another blade by loosening nut 22 by an amount sufficient to allow pins 40 of stabilizing washer 24 to be withdrawn from apertures 41 of blade 10, and to allow stabilizing washer 24 to be rotated with respect to blade 10 to align arms 27 of stabilizing washer 24 with arms 34 of aperture 30 through saw blade 10. After nut 22 has been loosened and stabilizing washer 24 has been rotated into proper alignment, saw blade 10 is pulled off of shaft 16 or 16′ with stabilizing washer 24 and nut 22 passing through aperture 30 of blade 10. A new blade may be installed on shaft 16 of FIG. 6 or shaft 16′ of FIG. 7 by reversing the process, i.e., passing nut 22 and stabilizing washer 24 through a suitably configured aperture in the blade, positioning the blade on step portion 50 or washer 50′, rotating stabilizing washer 24 to prevent passage of the stabilizing washer through the aperture 30 in quick-change blade 10, and tightening nut 22.

The quick-change system of this invention substantially reduces the amount of time needed to replace a circular saw blade or other tool implement on a power driven rotatable shaft, and substantially reduces the risk of loosing nuts, washers and the like during changing of a saw blade or other rotatable tool implement.

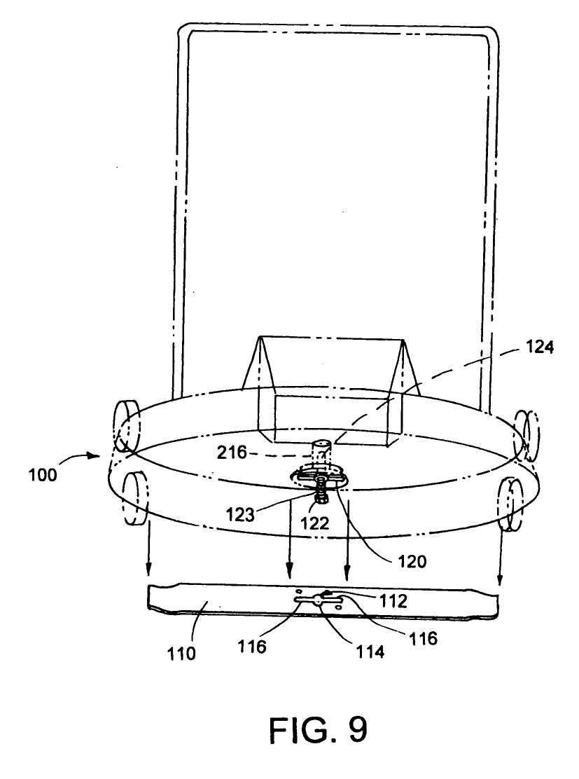

In FIG. 9, there is shown a lawnmower 100 (in dashed lines) employing a quick-change lawnmower blade 110 in accordance with the principles of this invention. Lawnmower blade 110 includes an aperture 112 having a circular portion 114 and arm portions 116 which project radially away from circular portion 114. Aperture 112 is configured (sized and shaped) to allow a stabilizing washer 120 and bolt head 122 of threaded bolt 123 to pass through aperture 112. This allows blade 110 to be removed from lawnmower 100 and replaced with another blade without removing threaded bolt 123 from internally threaded bore 124 of driven rotatable shaft 216.

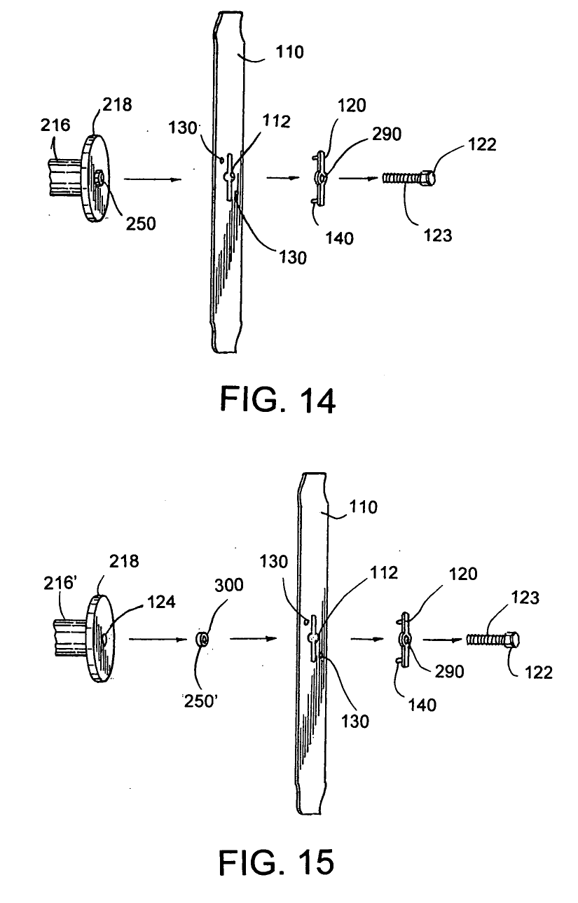

As shown in FIGS. 14 and 15, blade 110 includes circular apertures 130 for receiving pins 140 (FIG. 13) of stabilizing washer 120.

Quick-change lawnmower blade 110 may be utilized with a drive shaft 216 that is preconfigured with a circular integral step portion 250 on flange 218 (FIG. 14), or a washer 250′ may be employed (as shown in FIG. 15) instead of step portion 250.

As shown in FIG. 11, lawnmower blade 110 is held between annular flange 218 and stabilizing washer 120 by bolt 123, with pins 140 of stabilizing washer 120 disposed within apertures 130 of blade 110. As shown in FIG. 11, pins 140 may extend all the way through blade 110 and into bores in the face of flange 218. This helps prevent slippage of blade 110 with respect to flange 218. Slippage can also be positively prevented by utilizing a step 250 with noncircular edge walls which engage ingress noncircular wedge walls of the central portion 114 of aperture 112.

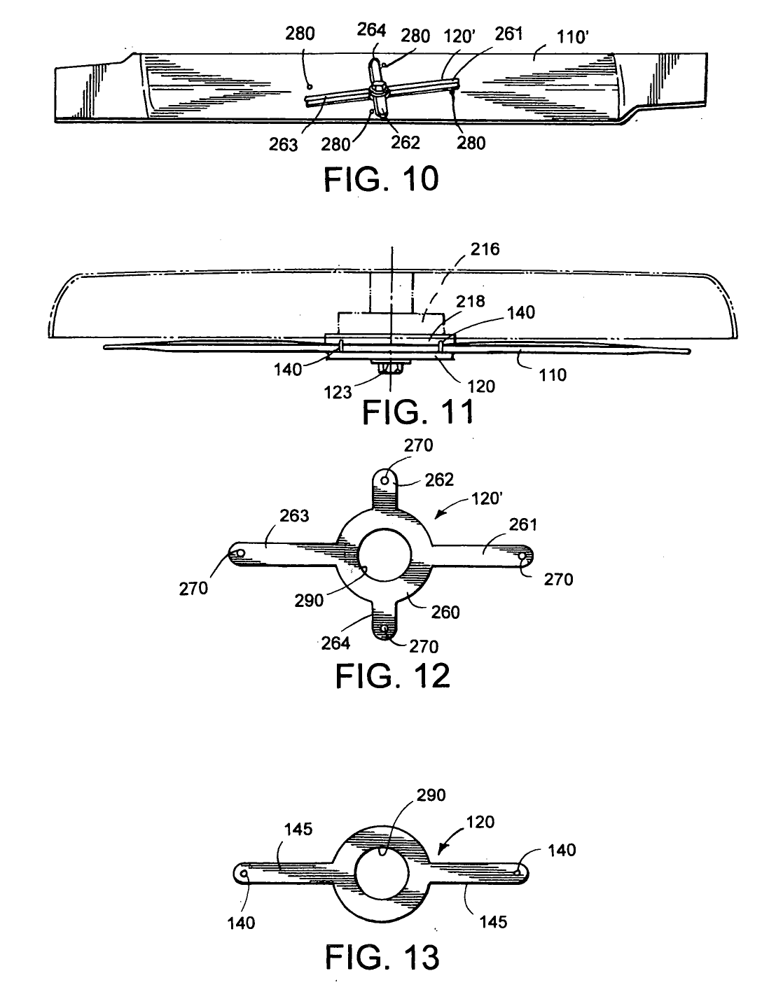

FIGS. 10 and 11 show an alternative embodiment in which quick-change lawnmower blade 110′ has a cross-shaped aperture that allows passage of a cross-shaped stabilizing washer 120′. As shown in FIG. 12, cross-shaped stabilizing washer 120′ includes a hub portion 260, and arms 261, 262, 263 and 264 which extend radially away from hub portion 260. FIG. 10 shows arms 261-264 in alignment with the cross-shaped aperture of lawnmower blade 110′ to allow installation or removal of blade 110′. After changing blades, stabilizing washer 120 is rotated slightly in a clockwise direction so that pins 270 of stabilizing washer 120′ are inserted into apertures 280 of blade 110 to prevent rotation of stabilizing washer 120′ with respect to blade 110′.

FIG. 14 illustrates installation of quick-change blade 110 on a shaft 216 having an integral step 250 configured to receive blade 110. Initial installation involves positioning blade 110 on step 250 so that the walls of the central portion 114 of aperture 112 abut the side walls of step 250. Thereafter, stabilizing washer 120 is positioned over blade 110, with pins 140 located in apertures 130. Then bolt 123 is inserted through the central aperture 290 of stabilizing washer 120, through the central portion 114 of aperture 112 through blade 110, and into the threaded bore 124 in shaft 216. Bolt 123 is then threaded into the bore and tightened to secure blade 110 and stabilizing 120 between flange 219 and head portion 122 of bolt 123. However, replacement of blade 110 does not require removal of bolt 123. Instead, bolt 123 is loosened sufficiently to allow pins 140 to be withdrawn from apertures 130 in blade 110 and to allow rotation of stabilizing washer 120 with respect to blade 110 to facilitate alignment of arms 145 of stabilizing washer 120 with arms 116 of aperture 112 whereby blade 110 can be passed over stabilizing washer 120 and bolts head 122 without removing the stabilizing washer 120 or bolt 123. A new blade 110 may be installed by reversing the process.

FIG. 15 shows use of the quick-change blade 110 on a shaft 216′ having a flat face on flange 218, without an integral step portion 250. Initial installation involves inserting threaded bolt 123 through the central aperture 290 of stabilizing washer 120, through the central portion 114 of aperture 116 through blade 110, and through aperture 300 of washer 250′. Thereafter, with the components arranged as described, threaded fastener 123 is inserted into threaded bore 124 and tightened, making certain that pins 140 are located in apertures 130 while tightening bolt 123. This facilitates quick removal and replacement of blade 110 with another blade, without removing bolt 123.

While the illustrated embodiments show fastener 22 and stabilizer 24 as separate elements, it is conceivable and within the scope of the appended claims that nut 22 and stabilizer 24 may be connected together in a manner that allows free rotation of nut 22 with respect to stabilizing washer 24. Similarly it is contemplated that bolts 123 and stabilizing washer 120 may be connected together in a manner that allows free rotation of bolts 123 with respect to stabilizing washer 120.

In addition to facilitating easy changing of saw blades and other rotatable tool implements, on a rotatable shaft, the quick-change mechanism of this invention is also useful for quickly changing tool implements on a post or handle of a hand operated tool, such as for quickly changing a scraper blade on a paint scraper.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

The invention claimed is:

1. A tool having a quick-change mechanism for replacing tool implements on a shaft, post or handle comprising:
a shaft, post or handle having a flange and a threaded connector;
a tool implement adapted to be received on the shaft, post or handle adjacent the flange;
a stabilizing washer adapted to be received on the shaft, post or handle adjacent the work implement; and
a threaded fastener adapted to be threaded onto the threaded connector of the shaft, post or handle whereby the tool implement and the stabilizing washer are retained on the shaft, post or handle by the fastener, and wherein the tool implement and the stabilizing washer are configured to allow removal of the tool implement without removing the fastener from the shaft, post or handle.

2. The tool of claim 1, wherein the stabilizing washer has a non-circular profile, and wherein the tool implement includes an aperture configured to allow the threaded fastener and the stabilizing washer to pass through when the tool implement and the stabilizing washer are arranged in a first conformation and prevent the threaded fastener and the stabilizing washer from passing through when the tool implement and the stabilizing washer are rotated with respect to one another into another conformation.

3. The tool of claim 1, wherein the stabilizing washer has a central hub portion and a plurality of arms that extend radially outwardly from the hub portion, and wherein the tool implement includes an aperture having a circular portion and a plurality of arm extending outwardly from the circular portion, the circular portion and the arms of the aperture being configured to allow the stabilizing washer and fastener to pass through the aperture when the tool implement is in a first orientation with respect to the stabilizing washer and prevent the stabilizing washer and fastener from passing through the aperture when the tool implement is in another orientation with respect to the stabilizing washer.

4. The tool of claim 1, wherein the threaded connector of the shaft, post or handle is an externally threaded portion and the threaded fastener is a nut receivable on the threaded portion of the shaft, post or handle.

5. The tool of claim 1, wherein the threaded connected of the shaft, post or handle is an internally threaded bore and the threaded fastener is a bolt receivable in the threaded bore.

6. The tool of claim 1, wherein the tool implement is a circular saw blade.

7. The tool of claim 1, wherein the tool implement is a lawnmower blade.

8. The tool of claim 1, wherein the tool implement includes at least one additional circular aperture, and the stabilizing washer includes at least one pin receivable in the circular aperture to prevent relative movement of the stabilizing washer with respect to the tool implement when the fastener is tightened.
